(19) United States
(12) Patent Application Publication
(10) Pub. No.: US 2022/0138765 A1
(43) Pub. Date: May 5, 2022

(54) Global Regulatory-Device Testing and Compliance-Life Cycle Management System

(71) Applicant: Global Validity Corporation, Raleigh, NC (US)

(72) Inventors: Richard Patterson, Wake Forest, NC (US); Robert Bolthouse, Pinckney, MI (US); Katherine Mansfield, Brentwood, NH (US); Jacob Stephen, Howell, MI (US)

(21) Appl. No.: 17/112,141

(22) Filed: Dec. 4, 2020

Related U.S. Application Data
(63) Continuation of application No. 17/085,674, filed on Oct. 30, 2020.

(51) Int. Cl. G06Q 30/00; G06Q 10/06; H04L 29/06; G06Q 10/10

(52) U.S. Cl. CPC G06Q 30/018; G06Q 10/103; H04L 63/20; G06Q 10/06313

(57) ABSTRACT

This document presents a system and method for managing the process of testing and/or certification and re-certification of devices in multiple countries. The certification system collects all information on the device from a requestor of service and manages the creation of quotes, manages the communication with suppliers in countries of interest to the requestor, provides a central repository for the collection, review, approval, and dissemination of all documentation for the device to complete a technical and operational certification. The certification system manages the project from initial document upload, through certification service, to completion and delivery of the certification approvals from the approval body in each country selected by the requestor.

### CLAIM TO PRIORITY

This application claims under 35 U.S.C. § 120, the benefit of priority as a continuation of the application Ser. No. 17/085,674, filed Oct. 30, 2020, titled “Global Regulatory-Device Testing and Compliance-Life Cycle Management System” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

A device testing and/or certification process must be performed for all electronic & electrical devices with or without communication capacity as part of the device capability prior to offering for sale in almost all countries around the world. Most countries have an established a testing and/or certification body to ensure the operation of new devices, and the continued operation of already certified devices, meets the standards set for the country in which the device is used. The process of testing and/or certification is highly technical and can be difficult, or even overwhelming, to manage when multiple countries and jurisdictions are involved, and when multiple devices must be certified or re-certified as to proper operation in the country or jurisdiction.

The manufacturer of the device must seek testing and/or certification within each jurisdiction and manage the information flow and timeline for the testing and/or certification, or re-certification, in each jurisdiction. This process may be similar in some jurisdictions, or may have very different requirements. Without a system in place to manage the projects for testing and/or certification, the manufacturer, or other provider, of a device must track and manage the entire effort of both initial device testing and/or certification and recertification, which is often times not the manufacturers area of expertise and can require much duplication of effort.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of the platform system implementation and method to collect data used to create analytics consistent with certain embodiments of the present invention.

FIG. 2 is a view of platform request, bid, manage, receive, and maintain functions consistent with certain embodiments of the present invention.

FIG. 3 is a flow diagram of the project testing and/or certification process consistent with certain embodiments of the present invention.

FIG. 4 is a flow diagram for the quote initiation process consistent with certain embodiments of the present invention.

FIG. 5 is a flow diagram for the quote submission process consistent with certain embodiments of the present invention.

FIG. 6 is a flow diagram for the project initiation from quote process consistent with certain embodiments of the present invention.

FIG. 7 is a flow diagram for the project requirements fulfillment consistent with certain embodiments of the present invention.

FIG. 8 is a flow diagram for the project tracking process consistent with certain embodiments of the present invention.

FIG. 9 is a flow diagram for the project fulfillment process consistent with certain embodiments of the present invention.

FIG. 10 is a flow diagram for the certificate tracking process consistent with certain embodiments of the present invention.

FIG. 11 is a flow diagram for the certificate renewal quoting process consistent with certain embodiments of the present invention.

FIG. 12 is a flow diagram for the budget quote process consistent with certain embodiments of the present invention.

FIG. 13 is a flow diagram for the message center operation consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “Certification Compliance Management System or Platform” also includes the Testing and Certification Compliance Management component of the certification system platform.

The document makes reference to a GVID, the GVID is a traceable identifier assigned to product creations that organize and track all connected quotations, projects, testing, certifications, chats, and other activities relating to the same GVID identifier.

This document presents an innovative platform that addresses the registration, testing, certification, and regulatory management process for electronic and electrical devices throughout the world to reduce the burden on manufacturers, service providers, Suppliers, Testing, Inspection and Certification Laboratories (TICs), Partners, and other entities who may use the platform for device testing and/or certification. The certification compliance management platform presented herein may protect a manufacturer's technologies from public disclosure during competitive bidding, program management, and application submission for product testing and/or certification and approvals. The certification compliance management platform and methods for implementing the testing and/or certification process eliminates the unnecessary distribution of private data to unknown sources that may not be covered by legal or ethical directives in properly handling of product information with un-secure, non-encrypted passing of information and retention in un-secure, un-locked devices. The methods implemented on the certification compliance management platform may protect all communications and data exchanged in the platform by tracking each user's access identity with timestamp markers and assigned data identifiers. All users require server credentials to access the certification compliance management platform with browsers that are fully compliant in connecting through the private-key application-locked encryption to the server. At connection, all communications, data, images, and file transfers between credentialed users in the certification compliance management platform are encrypted, secured, timestamped, and imprinted with that user's identifier. Data files, documents, and images transported into and out of the certification compliance management platform are retained at rest in secured locked storage locations that require the certification application's connection key-code to unlock and grant access.

At least one innovative method significantly improves dataflow efficiency by allowing product profiles to be created and staged for all suppliers, agents, advisors, and consultants to view the content details uniformly. The innovative method accelerates the process by allowing the experts to communicate in the same engineering language directly with their peers, manufacturer engineers communicating to compliance engineers, eliminating man-in-the-middle interference. The innovative method requires suppliers to pre-assign required documents, pre-access the delivered documentation, and pre-assemble the submission requirements that are transmitted to the regulating jurisdictions. The supplier securely transfers and receives an acknowledgment that the application for approvals was submitted with a timestamped receipt of accepted.

In an embodiment the innovative certification compliance management platform and process provides a cloud-based, global regulatory certification and compliance capability for electronic and electrical devices. This testing and/or certification is a requirement for electronic and electrical devices throughout the world. The innovative platform and process provides users in countries all over the world with a central platform for the specification, collection, and approval of all documentation required, on a per country basis, to request and receive operational testing and/or certification of electronic and electrical devices in each country.

The innovative certification compliance management platform and method presents authorized users with a centralized location to interact with service suppliers in or supporting each country into which the authorized user wishes to certify or re-certify new and/or existing electronic and electrical devices. The platform and method automates and manages the global testing and/or certification process, again, on a country-by-country basis. A large part of the testing and/or certification process, regardless of country into which a device is to be certified, is the request for quotes, request for documentation, and working with service suppliers in each country to ensure that all appropriate documentation has been supplied and approved for the device testing and/or certification. The platform and process establishes a repository for all documents, as well as coordinates and manages all test samples and device samples and manages all steps of the testing and/or certification process.

The innovative platform provides users and suppliers with a complete communication device for regulatory certification life cycle. This process may include the collection of all device documentation and product samples, manages project tracking from quote to final testing and/or certification, eliminates reliance on corporate knowledge of individual personnel, permits a full-time audit and market surveillance readiness for each device. The innovative platform enables an accelerated time to market for devices by providing communication directly to suppliers of testing and certification services in each country, provides a central document repository for a single upload of all documents, lists of supplier required documents and samples for access by a user, and managing approvals and completion of the compliance tasks to streamline the testing and certification process.

This centralized capability of the platform to collect and manage the testing and/or certification process for each device fosters cost reduction for users through market-place pricing, elimination of duplication of effort and ease of use of both monitoring and tracking the testing and/or certification steps for each device. Additionally, the platform provides for transparency between users and suppliers, requesting project tracking, and tracking testing and certification from a request to quote through to the final testing and/or certification issue. The platform also fosters collaboration between users, suppliers, and interested third parties by establishing access rights and tracking all interaction for each project managed within the platform. The platform may serve as a smart repository for all issued certificates, maintaining the status of each certification and supplying certificates of compliance to only those having the right to request and view each certificate. The platform and method provide dynamic notification capabilities at each point within the process of testing and/or certification where such notifications take the user directly to the point of action within the testing and/or certification process for each requested communication device.

In an embodiment, the Competitive Market Place for country requirements drives suppliers to differentiate. Global Validity (GV), TIC, Partner or Client may name the supplier who provides information resulting in Supplier demonstrating the expertise opportunity to engage early with potential client or GV/Partner/TIC project managers. Suppliers are able to store and manage compliance requirements to support the effort for testing and/or certification projects. Early contact with a potential customer or TIC project manager increases close rates for suppliers.

In an embodiment, GV qualified suppliers TIC suppliers, Client suppliers, or Partner suppliers compete for certification and related services including but not limited to consulting, testing and certification, environmental, security, medical registration, etc. in 200+ countries and are connected through the certification compliance management platform to a testing and/or certification supplier market place. The Competitive Market Place drives suppliers to market themselves via the platform's Supplier Information area. Expertise, experience, and full contact details are provided.

The certification compliance management platform directs communication with Suppliers, Managed Service providers, TICs, GV, Partners, Clients, and internal stakeholders. Internal communication between users. Highly organized (by project, by country within a project, by supplier) and searchable. This capability replaces external email programs. The certification compliance management platform presents a highly organized capability to add countries or re-certify products on a per country basis.

In an embodiment, the budgetary quoting system enables suppliers to load generic pricing by technology and country for budgetary quoting. Maintained directly by the suppliers in the platform. Enables users to request budgetary pricing without formal quote burden on suppliers. Suppliers notified of budgetary quote request. System auto populates pricing for suppliers from previously loaded generic pricing. Supplier reviews budgetary quote (optional step in TIC, Partner and Client version) and approves or adjusts the budgetary quote, as necessary. All quotes are sent to client via platform for review & download (client notified via communication portal). The quote system automates formal quotes that enable country selection, automated or customized supplier selection (adjustable limits), quote request notification to supplier, quote delivery w/notification to user, summary view, supplier quote view, easy comparison & selection process, roll-up to single quote for placing order.

In an embodiment, the Project Management System is a module configured to manage and track testing and/or certification projects. This module within the certification compliance management platform enables sample instruction and shipping information/tracking, easy to see clickable progress graphics (document upload, launch, multi-level status reports) checklist compiler, automatic parsing of documents including new countries when added (uses existing documents if already available), document control w/security (upload/download tracking), supplier direct status updating, historical view of estimated completion date changes, launch date tracking with at risk system notifications, individual supplier filters, status reporting (exportable high level report pulled detailed project management view) by responsibility (what a project manager may have going on), by project, by all (open or closed), supplier rating and certificate approval, certificate delivery into project with expiration date, auto tracking & notification.

The project management system component of the certification compliance management platform manages projects for specific jurisdictions and specific countries. The project management system tracks progress and supplies project status upon demand, including what actions are required by the requestor and suppliers. The project is managed such that country and jurisdiction requirements are transmitted equally to requestor and suppliers and all communication and documents are centrally managed within the certification compliance management platform. As a part of the project management and tracking process, the requestor sets their expectations for project completion, as well as indicating the status of any project as on hold, in progress, cancelled, or issues.

The certification compliance management platform is an open market system where suppliers are visible and accessible to the Requestor. Requestors enter the product details and select-assign the technology protocols that has been designed in their product. Suppliers are qualified to service any technology protocols selected, wherefore when the Requestor puts their product out-for-bid in this market place the communications and dataflow mapping is straight-lined. Requestor's chats and data share is directly passed to the supplier(s) and/or project manager. Supplier chats and data share are provided directly to the requestor and/or optionally forwarded to requestor and/or customer with supplier information hidden. The supplier can view all the product design aspects without downloading and distributing the materials. The certification compliance management platform coordinates and stores the passing of this information for historical purposes.

In support of all testing and/or certification project efforts, the testing and/or certification contains a Secure Smart Repository available to authorized users. The smart repository enables easy search for certifications, test reports, and compliance documents that are both current and including indefinite and expired certificates. The documents and certifications are searchable by product, by country, and are available for upload and/or download. The smart repository also provides storage and tracking of compliance documents, such as certificates, reports, labeling, etc., that are associated with each certification record.

The certification compliance management platform also provides a customizable system notifications capability to manage expiring certifications. In support of maintaining valid certifications for previously certified devices, the certification compliance management platform provides an automated re-certification capability that pulls all initial data from all stored testing and/or certification documents and files, effectively enabling immediate re-certification quote requests without additional documentation and providing confirmation of all documents, records and samples previously provided.

The certification compliance management platform maintains a strong security practice through the implementation of a robust user rights capability. User rights are highly configurable in the certification compliance management platform enabling collaboration globally through transparency to authorized users. The user rights capability provides multiple levels of security by restricting access to information to only those who are authorized for the information, and separately restricting actions to only those who are enabled to act on behalf of the supplier or requestor. The user rights are established initially when a new user is onboarded to the certification compliance management platform but may be changed dynamically as necessary and with appropriate approval.

The certification compliance management platform also contains a robust system notification capability. System notifications may be automatic notifications to suppliers, TICs, Partners, Clients, requestors, or other authorized third-parties for multiple status changes, including but not limited to quotes received, new communication, certificates received, expiring certificates, requests for information, broadcasts by the certification compliance management platform or testing, inspection, certification (TIC) and Partners suppliers to customers base or supplier base.

The certification compliance management platform has created and operates a qualification training program for users. This training program includes multiple levels of certification. In a non-limiting example, Basic vs Master certification programs and everything in between. The training program consists of a stringent curriculum that a user must master and of which the user must demonstrate proficiency to be certified. The certification compliance management platform training program will issue official certificates of completion once a user has completed and mastered a training program.

The certification compliance management platform may issue a Certification Quality Mark and Certificate, issued Global Validity (GV) Mark, as a GV mark, for manufacturers that use the Global Validity solution as operated by the certification compliance management platform. Certificates containing the GV mark may be issued for platform, process, qualified suppliers, tracking, and audit/market surveillance readiness. Certificates obtained containing the GV mark are indicators of a high standard of compliance performed by GV qualified suppliers and certification as certified by the GV certification compliance management platform training process.

Analytics—The certification compliance management platform, when in operation, structurally records, measures, and reports all metrics and data points contained within each platform module with complete reporting capability.

In an embodiment, the certification compliance management platform is a closed system in which the certification process provides all communication between the requestor and supplier in each selected country. To begin the process, the requestor initiates a quote request via email to a local salesperson or a GV Partner or TIC that is capable of performing the testing and/or certification service for a new device or a device being recertified. The salesperson may then forward the details of the request to a certification compliance management platform in-house specialist person or group and submits a quote request via the platform to suppliers depending upon the country and/or jurisdiction requested. If there are questions regarding the technology upon which the device is created or methods of testing, the requestor or service supplier may propose question(s) to the in-house specialist using the platforms secure communication portal. The in-house specialist becomes the intermediary to coordinate all communications between all parties for any technical clarification required or any jurisdictional questions. GV Partners and TICs seek competitive pricing, which means that multiple suppliers in any country or jurisdiction are included in the quote process.

Each GV Partner, TIC, user, and the supporting suppliers increases exponentially the distribution requirements for all materials to be distributed by the in-house specialist to manage the quote process via email and certification compliance management platform. Every person that is engaged in this process must receive technical documents that have the potential to be stored on local locked and open devices, multiple servers, personal mobile devices, or other storage locations that can be located in local, national, or international facilities. The transmission of confidential materials to these devices may not be encrypted, secured, or directly owned by the Partners, Third Parties, TICs, or suppliers contacted for service. When a bid is awarded to a supplier, redundant copies and iterations of the distributed confidential materials may no longer be managed by the system. These redundant copies and/or iterations may comprise a large portion of the confidential materials that have been distributed and the possibility exists that these materials may not be destroyed.

In an embodiment, data transmission from one entity to another and all communications between parties during a testing and/or certification engagement is managed by the certification compliance management platform. All communications are encrypted, and data security is managed through the use of the most up to date connection and data security technologies prior to any communication or data transmission to external networks outside of the certification compliance management platform. Users must be granted access into the certification compliance management platform with an active account and password. With each user connection the certification compliance management platform monitors the date, time, location, and activities of the user when engaged with the certification compliance management platform. When a user uploads or downloads data certification compliance management platform tracks the activity of the user by associating the user identity, a timestamp, and an identifier for each item of data selected. The primary mode of communication is through the secure communication portal email of needed files between the requestor and suppliers. By encrypting communications and providing robust data security, the risk of accessing or measuring the details on requests of data, transmission of data, or acknowledgement of receipt of data is minimized and, in most cases, reduced to zero.

In an embodiment, naming and labeling nomenclature is important in all jurisdictions and may be different in each. For this reason, all documents incoming and outgoing files received, maintained, stored, or otherwise operative within the certification compliance management platform may be renamed to a pre-defined nomenclature configured by each individual user and organizing the incoming or outgoing files according to a pre-defined nomenclature created and used by the certification compliance management platform.

In an embodiment, when the supplier, agent, or consultant receives all the requested documents from the requestor the supplier compiles the submitted documents in the certification compliance management platform and prepares the necessary applications required by the jurisdiction's certification body in the data repository within the certification compliance management platform. Once all the requestor documents are approved and applications are prepared, the supplier can transmit the full application and documents to the certification body for the country or jurisdiction of interest to the requestor. The initiation of the transfer copies the documents from the requestor and supplier to the Certification Body Portal or other means as defined by certification body. The Certification Body Portal can be hosted on the certification compliance management platform server or can be deployed on the Certification Body's Platform.

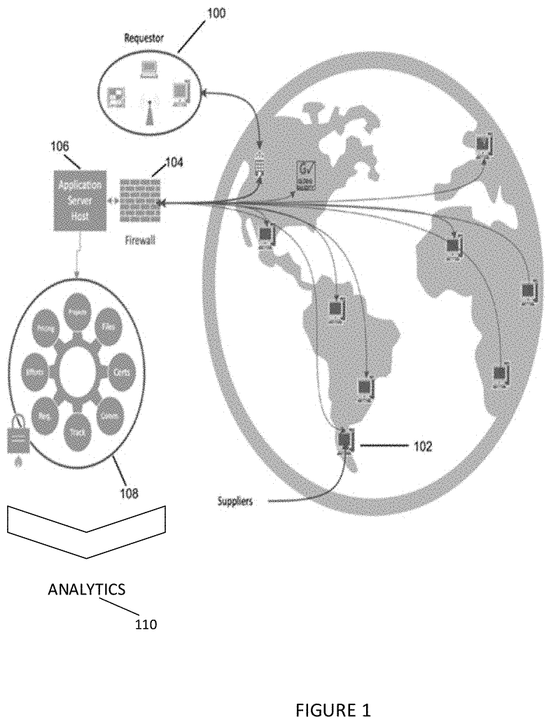

Turning now to FIG. 1, this figure presents a view of the certification compliance management platform system implementation consistent with certain embodiments of the present invention. In an exemplary embodiment, the process of testing and/or certification for a device is initiated by a requestor 100. The testing and/or certification process is tracked and managed through platform process control. This platform process is where all chats, discussions, inquiries, responses, documents, data, management planning, project tracking, delivery efforts, performance timing, pricing, approvals, and certificates are synchronized, managed, stored and relationally related as informational, measurables, and deliverables datapoints for the testing and/or certification and approvals industry. There are no other known application services that are engineered, developed, and implemented for the testing and/or certification and approvals industry.

The requestor 100 may be a company or individual that has a product that requires testing and/or certification approvals to market, offer for sale, import, or operate the device within the geographic boundaries of a country or countries. Suppliers 102 may be agents, advisors, consultants, companies, and organizations that are located in various countries around the world. Suppliers 102 may be contacted by the requestor 100 to provide services such as consultation, advice, or action on certification up to, and including, management of the testing and/or certification process, the testing services, obtaining and or the generation of certificates attesting to the compliance of the requestor's 100 device for a particular country. Both requestors 100 and suppliers 102 may be connected to the certification compliance management platform through a protective firewall 104 and directly to the application hosted by the certification compliance management platform in operation on the application host server 106. Information is shared from requestors 100 and suppliers 102 through direct transmission to the application host server 106, where all information transmitted is encrypted and otherwise protected by data communication security processes occurring in the certification compliance management platform. The certification application installed and active on the certification compliance management platform manages, processes, engages, coordinates, gathers, retains, and locks all information about the Product(s). The testing and/or certification application manages Projects by tracking and providing Service management to achieve approvals, manages Data and Documents files and Certifications Documents. Integral to the process are the control and management of Communications such as Chats, Descriptions, Briefings, and Notes to and from suppliers, requestors, and third-party participants. The testing and/or certification application maintains the project management history to Track every project from start to completion and provides each party, suppliers, and requestors, with all jurisdiction requirements from labeling to standards for each testing and/or certification in the country and jurisdiction desired. The testing and/or certification compliance management platform details projected and actual project efforts and supports open market competitive bidding for all pricing of testing and/or certification services. The elements of the data and documents managed by the testing and/or certification application are represented in the diagram in the locked data sphere at 108. The certification compliance management platform permits the analysis, synthesis and reporting of all information entered into the system for testing and/or certification services in an analytic module at 110.

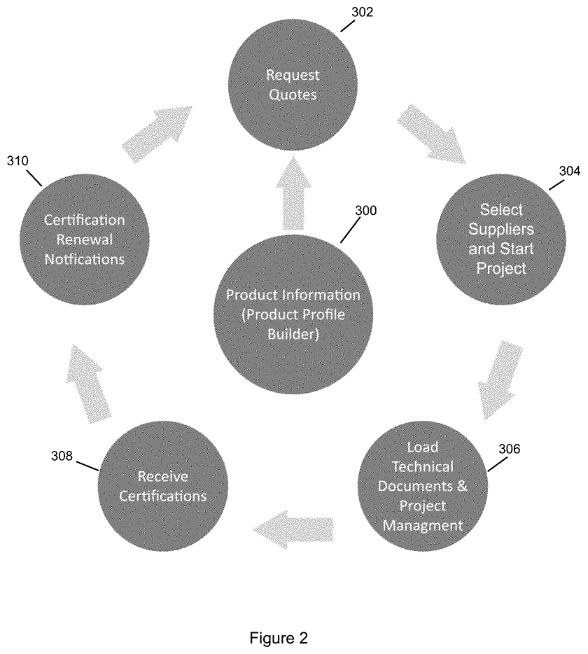

Turning now to FIG. 2, this figure presents a view of platform request and bid functions consistent with certain embodiments of the present invention. In an exemplary embodiment, a lifecycle exists for the generation and completion of testing and/or certification for each device. This figure presents a functional view of the basic testing and/or certification approval process. To begin the process at 200 a requestor submits a product profile to the certification compliance management platform which opens and begins to build a profile for the product to be certified. At 202 the testing and/or certification application installed and operational on the certification compliance management platform transmits the product profile information to the request quote process. The request quote process begins the testing and/or certification approval process cycle.

At 204 the information is passed to the desired number of suppliers for or in each country in which the requestor seeks to certify the indicated device. The bids are collected from the selected suppliers and an acceptable bid is selected by the requestor for the supplier(s) to be used in each country. Upon selection of the suppliers, requestor places order through multiple payment options, where payment options may include payment via a credit card, PayPal, Venmo, purchase orders, and other defined payment options, the system opens a project file. At 206 the testing and/or certification application loads the technical documentation and any sample information and begins the process of tracking and managing the testing and/or certification process for the device. The testing and/or certification process continues, dynamically tracked, and managed by the certification application, until the conclusion of the testing and/or certification process and the issuance of device certifications in each country for the device. At 208 the testing and/or certification application receives the certification documents from each supplier, placing a copy in the device file maintained within the certification compliance management platform, indexed by the requestor and device being certified, and transmits the original certification to the requestor. At 210, the testing and/or certification application continues to track the testing and/or certification status for each requestor and device in the project database. When certification renewal is required, the testing and/or certification application will create a notification that re-certification is required and transmit this notification to the requestor. Due to the maintenance of project and testing and/or certification information for each requestor and device, the testing and/or certification application may enter the request quote process upon an indication from the requestor that they wish to re-certify the device and the process begins anew.

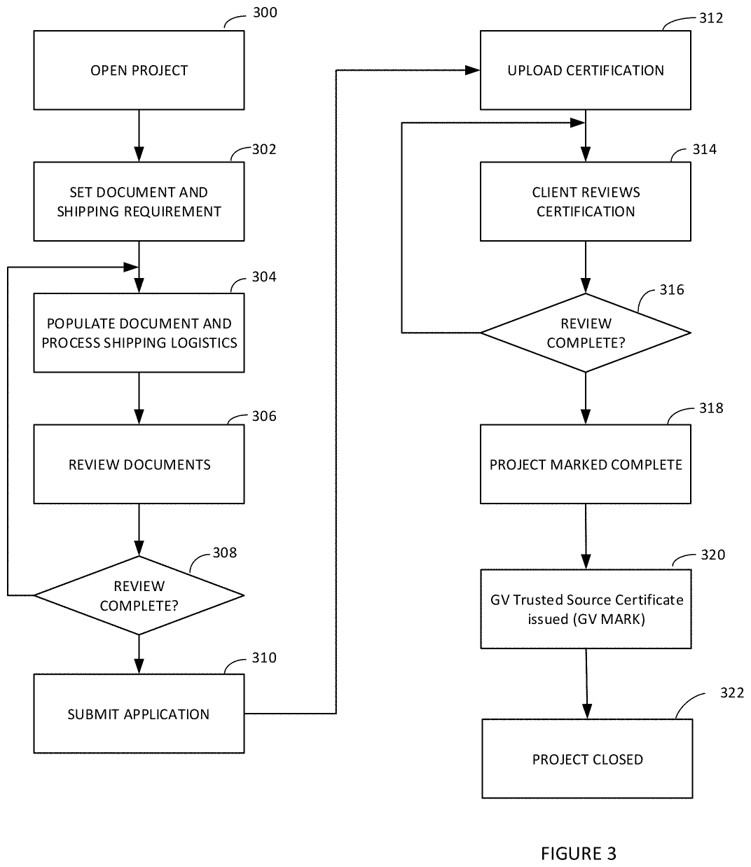

Turning now to FIG. 3, this figure presents a flow diagram of the project testing and/or certification process consistent with certain embodiments of the present invention. In an exemplary embodiment, the project testing and/or certification process begins with the opening of a project at 400 where the project is tracked and managed by the testing and/or certification application operative within the testing and/or certification compliance management platform.

When opening a project, the contracted testing and/or certification supplier(s) transmit the product documentation and shipping requests needed to complete required testing and/or certification application services to the project requestor at 302. The requestor must upload the documents required by the suppliers and process the shipping logistics to send any samples to the supplier, or instructed location, and to transmit any documents that may be required in hard copy to the address of the supplier(s), or instructed location, at 304. The testing and/or certification application may then present documents supplied for review by the supplier to ascertain completeness and accuracy of information requirements at 306. At 308 the testing and/or certification application queries the suppliers as to the completeness of the document review to determine if all information has been supplied and all information is accurate. If the document review is incomplete, if there are missing items, or if the documents contain inaccurate information a communication is sent to the requestor to update the documents and/or provide additional information or documents, returning to step 304.

If all information and documents supplied are complete and the review is done the certification supplier submits the application for testing and/or certification service to the Certification Body at 310. The selected supplier(s) will then liaison the application process and communicate any questions, concerns, and/or issues that are received from the Certification Body back to the requestor. At the completion of the testing and/or certification service at 312 the notice of completion and a testing and/or certification verification is transmitted from the supplier to the testing and/or certification Requestor. At 314, the project management module of the testing and/or certification application communicates the testing and/or certification results and verification to the requestor. At 316, the requestor reviews the testing and/or certification results and verification. At 318, the project management tracking module queries the requestor as to the status of the review. If the review is incomplete or the requestor has questions, issues, or comments on the testing and/or certification results the project management tracking module communicates this information to the supplier and returns to step 314.

If the requestor review is complete the requestor transmits this information to the project management tracking module by marking the project as complete at 318. The project is identified as closed by the project management tracking module and the testing and/or certification results, including any certification certificate, report or approval, are transmitted to the requestor at 320 and is automatically delivered into the certificate tracking tool. The project is then closed at 322.

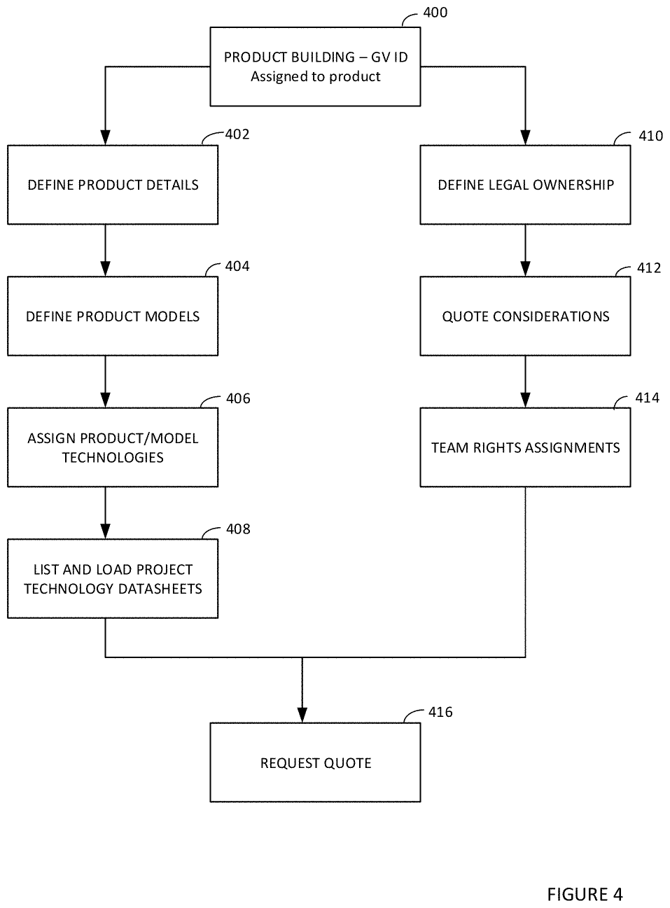

Turning now to FIG. 4, this figure presents a flow diagram for the quote initiation process consistent with certain embodiments of the present invention. In this embodiment, at 400 the quote initiation process begins with building the parameters and information for the product that is the subject of the requested quote. At 402, the requestor opens the appropriate form in the user interface provided by the quote subsystem of the certification compliance management platform and enters the details of the product that is the subject of the quote to be prepared. Information sought from the requestor may include product technical specifications, operation parameters, markets to be addressed by the device, and consumer groups to be targeted when marketing the device. At 404, the system permits the requestor to enter the product models for the device to be certified. As part of the product model data the requestor may enter any industry assignments and SIC codes that pertain to the product model or models that are the subject of the quote request. At 406, the system permits the requestor to assign product/model technologies to the device, electrical specifications, and international tariff code(s)(HS Code) The quote subsystem may present a list of technologies from which the requestor may select the appropriate technology that applies to the device, or the requestor may input a technology different from those presented in the list of technologies, which may include, in a non-limiting example, technologies such as Bluetooth, Wi-Fi, RFID, Cellular, and other technologies to be specified. At 408, the quote subsystem presents the requestor with a list of required technology datasheets that are required and provides the requestor with the opportunity to upload the technology datasheets into the system.

Simultaneously, at 410 the requestor may be presented with an input field to input a definition of the legal ownership of the device, including applicant information, legal entity ownership, and brand/trade names that is required to appropriately identify product and quote validity. At 412, the requestor may be presented with a display listing quote consideration(s) with which the requestor must comply to have the quote prepared by the quote subsystem. At 414, the system permits the requestor to input team rights assignments for the device. Upon entry of all required information, datasheets, definitions, and assignments, the requestor may submit the request for quote at 416.

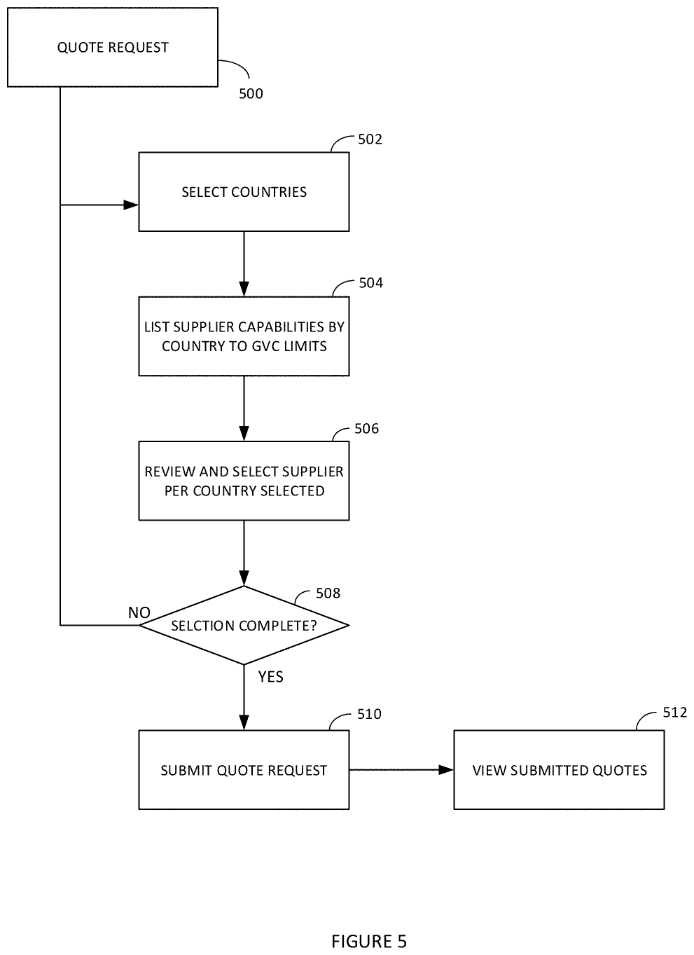

Turning now to FIG. 5, this figure is a flow diagram for the quote submission process consistent with certain embodiments of the present invention. In this embodiment, at 500, the requestor has completed entry of all the information required to populate a quote and has requested the preparation of a quote from the quote subsystem of the certification compliance management platform. At 502, the requestor is provided the opportunity to select the countries from a provided list of countries for which the quote for testing and/or certification service is sought. At 504, the quote subsystem will provide a list of supplier(s) available to support certification services in each country. The list may be organized by country up to the limit of information contained within the certification compliance management platform database. The list may be presented to the requestor as a pop-up list from which the requestor may select those suppliers from which they are interested in receiving a quote.

At 506, the requestor may review and select suppliers of service from each country. As a service to the requestor, the quote subsystem may present an indication on the display of those suppliers that have preferred status and ratings compiled by other requestors, or from Global Validity, for each supplier. These status and ratings indications provide a requestor with additional assurance that the quotes requested will be accurate and the service provided will be of a sufficient quality of performance. At 508, if the selection by the requestor is incomplete, or if the requestor wishes to update the list of countries for which testing and/or certification supplier quotes are sought, the quote subsystem may return to step 502 to present the requestor with the ability to select additional countries to select suppliers from which to request a bid.

If, however, the requestor selection is complete the requestor may submit the quote request at 510. The requestor may also access, and review all submitted quotes at 512 for tracking and assurance purposes. The quote subsystem will present an editable list of all submitted quotes categorized by requestor, device, and country.

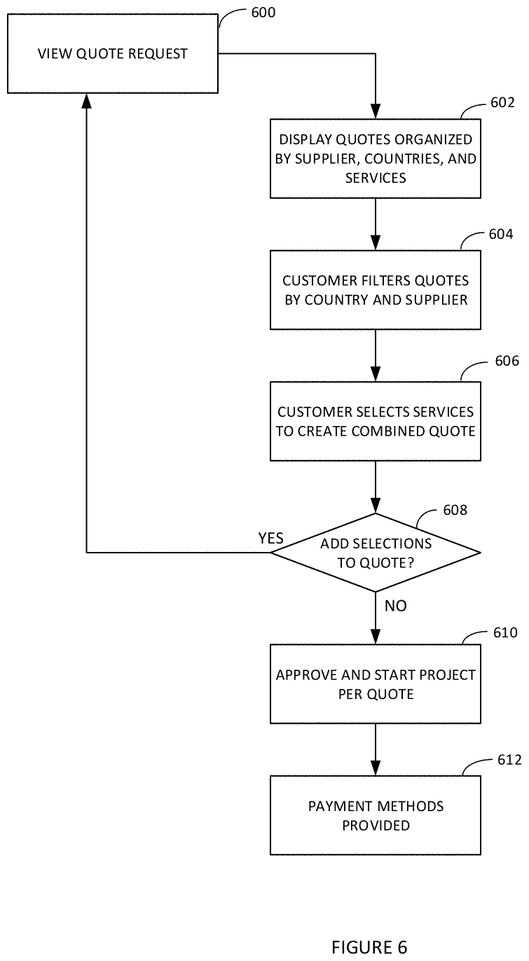

Turning now to FIG. 6, this figure presents a flow diagram for the project initiation from quote process consistent with certain embodiments of the present invention. In this embodiment, at 600 the requestor has asked the quote subsystem of the certification compliance management platform to review quote requests associated with the requestor. At 602, the quote subsystem may display all quotes for the requestor organized by supplier, countries requested, and services requested and/or determined to be required by the requested supplier(s). Additionally, the quotes supplied may be filtered by country, supplier, pricing, lead time and/or user performance reviews on previous projects. The supplier performance is gauged by in-company ratings on each supplier, quote turn-around performance, project performance and other metrics that indicate on-time project deliverables and the quality of service as rated by other requestors.

At 604, the requestor filters through the quotes by country and supplier to make a decision as to whom the requestor will select as the service provider desired. The requestor may apply filters to the quotes listed that will filter for type of services. The filter may filter by one type of service over another service to focus on the metrics with each supplier's quoted text in-line with presented pricing information. Additional filters a requestor may select will filter the list of quotes by best pricing, best turn-around, and other pre-defined metrics stored within the system. At 606, the requestor selects the services desired, the suppliers desired, and the best filter for the requestor's purpose to create a combined quote. At 608, the quote subsystem inquires of the requestor as to whether their selections are complete. If the requestor has not completed their selections, or if the requestor wishes to change parameters for selection, the requestor will be returned to the view quote request screen at 600 to add to or modify quote selection.

If the requestor has completed all selections, at 610 the requestor will review the final combined quote for accuracy of supplier, service, price, country, and all other quote parameters and approve the quote. Upon approval of the quote the system will initiate a project within the testing and/or certification application and import all quote information to the project module, At 612, the requestor will be provided with a list of payment options and methods to supply payment to the system for the preparation and transmission of the final quote to the selected suppliers.

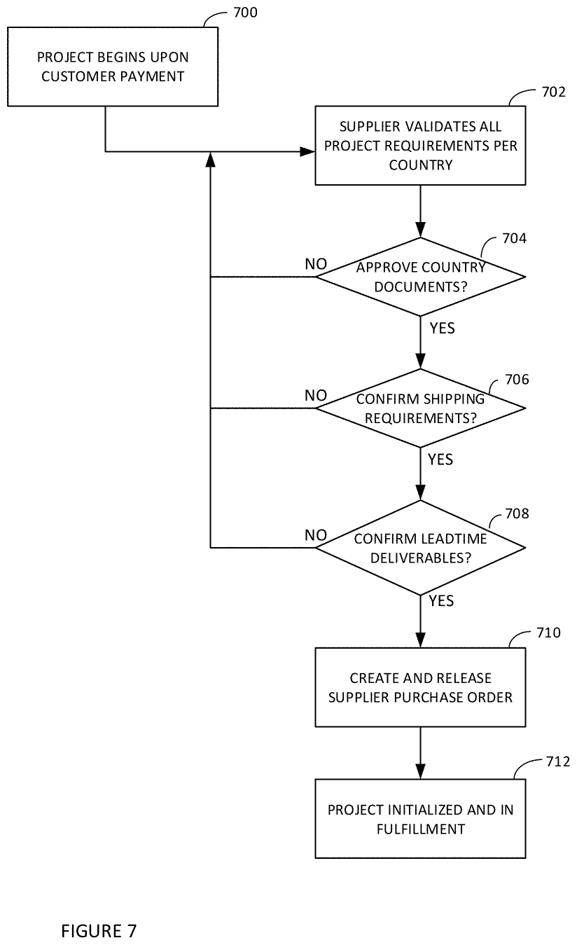

Turning now to FIG. 7, this figure presents a flow diagram for the project requirements fulfillment consistent with certain embodiments of the present invention. In this embodiment, at 700 upon accepted Purchase Order and/or approved payment method, the testing and/or certification application will indicate that the project for testing and/or certification of an input device by the requestor will begin and seeks final approval and verification by the supplier. In support of the supplier, the certification compliance management platform may automatically generate all supplier purchase orders (POs) and transmit these POs to the contracted supplier. At 702, the supplier selected for each country will validate all project requirements for the country in which testing and/or certification services are sought. At 704, the supplier will approve all country product documents required, remaining in the approval process until all country product documents have been completed and approved. At 706, the supplier confirms all shipping requirements for any sample devices that must be delivered to the supplier, or designated location, for certification testing and other certification activities. The project will remain in the approval review process until all shipping requirements have been transmitted and approved by the requestor and supplier. At 708, the supplier will submit, confirm, and/or modify lead time deliverables for each service requested within each quote received by the supplier. The project will remain in the preparation stage until all deliverables have been confirmed and approved by the supplier.

Upon confirmation of all documents, shipping requirements, and deliverables for the project, at 710. At 712, After all product and shipping requirements have been approved by the supplier the testing and/or certification project will initialize for action and place the project in the project management subsystem for tracking and fulfillment.

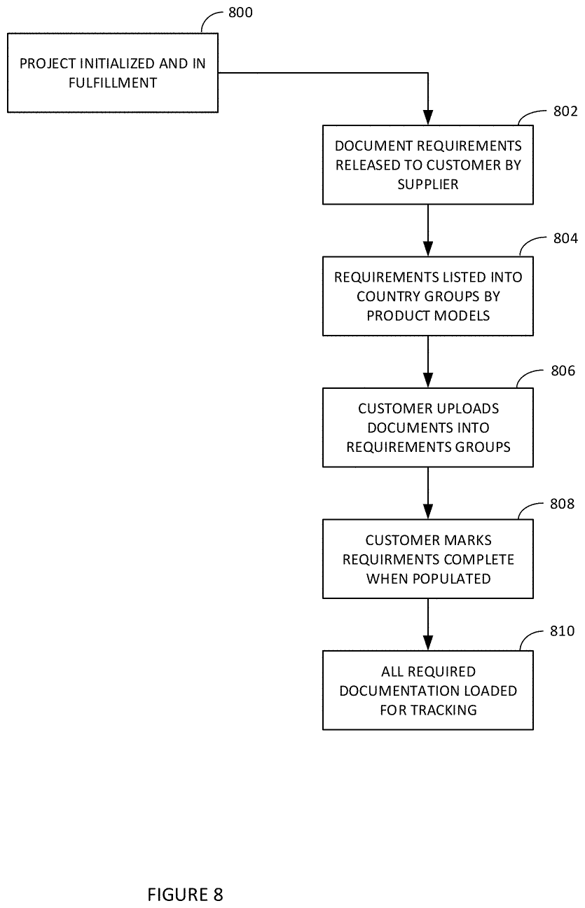

Turning now to FIG. 8, this figure presents a flow diagram for the project tracking process consistent with certain embodiments of the present invention. In this embodiment, at 800, the testing and/or certification application recognizes the project as fully initiated and in the fulfillment phase. At 802, the supplier releases all document requirements for the testing and/or certification process to the requestor of the testing and/or certification service. The testing and/or certification application checklist provides the supplier with a capability to create documents and forms for direct entry of information as required by the supplier and/or Certification Body. At 804, the documents required may be listed into country groupings by product models to be certified. The groupings enable the requestor to upload one-time product documents and those documents will be placed automatically to each country's folder that is requesting the same document. This process is completed and augmented by an ability to upload specialized Optical Character Recognition (OCR) formatted documents by providing an OCR scan capability to automatically scan, upload, and file documents that have been prepared in OCR format. At 806, the requestor may upload or create all documents required for the testing and/or certification service. The uploaded or created documents are loaded into requirements groupings and stored within the project folder for the particular testing and/or certification project. Document encoding into OCR format and document tracings are performed by the requestor prior to uploading or creating the required testing and/or certification documents.

At 808, the requestor is presented with a display of all documents listed by requirements groups, country and/or certification type and the requestor may check off each requirement group as being completed as the documents for that requirements group are finished and uploaded to the certification system. The document checklist will also track and provide a visual verification of the percentage completion of the document creation and upload as a percentage of all documents required by the supplier. The document checklist provides the capability to apply a private water mark for document security and as an aid in tracing the required documents. At 810, upon marking each requirement group as complete when all documents have been uploaded, the document upload is marked as complete by the project management tracking application and the documents are transmitted to the selected supplier to continue the testing and/or certification of the device(s).

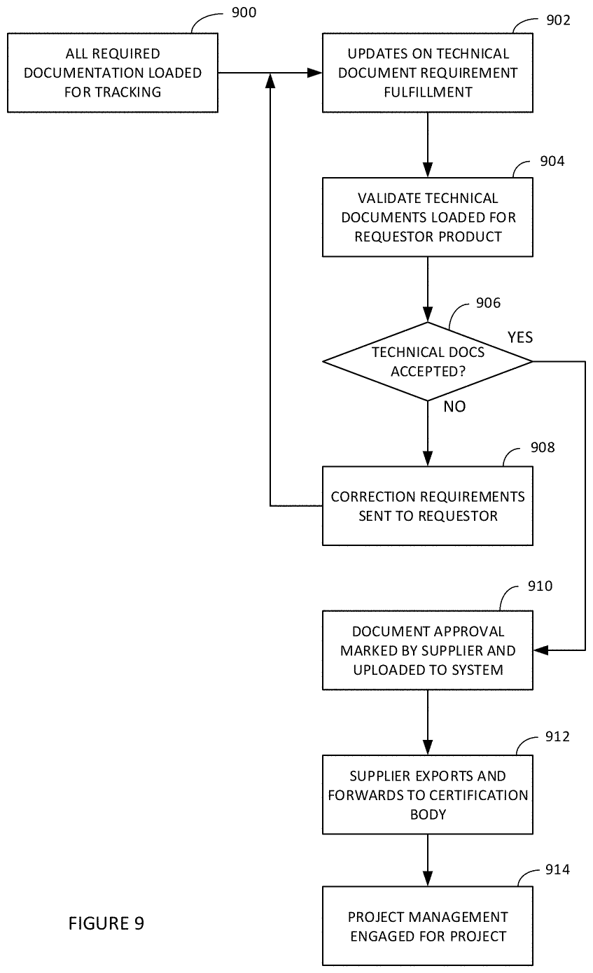

Turning now to FIG. 9, this figure presents a flow diagram for the project fulfillment process consistent with certain embodiments of the present invention. In this embodiment, at 900 the testing and/or certification checklist has verified that all required documentation has been loaded into the certification system. At 902, the certification system may provide the requestor with updates on the fulfillment of technical documents required. The certification body or supplier in each country may receive the document requirements directly from the certification system. The document checklist will track and time stamp each download of a document by a supplier. At 904, the supplier and/or the certification body may validate the technical documents that have been loaded into the testing and/or certification application project for the requestor product or device. At 906, the technical documents are reviewed by the certification body or service supplier to verify that the technical documents uploaded are acceptable per each country(s) testing and/or certification requirements. If the technical documents are rejected for any reason at 908 correction requirements for affected documents are formulated by the testing and/or certification supplier and transmitted from the supplier to the requestor. The process returns to step 902 to update the requestor on fulfillment of the technical documents required.

At 910, if the technical documents are sufficient, the supplier will provide verification of document to the requestor and upload the approval to the testing and/or certification application. All approvals and rejections are time stamped and tracked in a document control view. At 912, the supplier exports all approved documentation from the certification system and forwards the approved documents to the testing and/or certification body for the selected country. At 914, the project management subsystem is engaged for the project to manage all of the tracking and communication required to ensure that the testing and/or certification service is provided and that the results are provided to the requestor and testing and/or certification body to complete the testing and/or certification for the device in the selected country or countries.

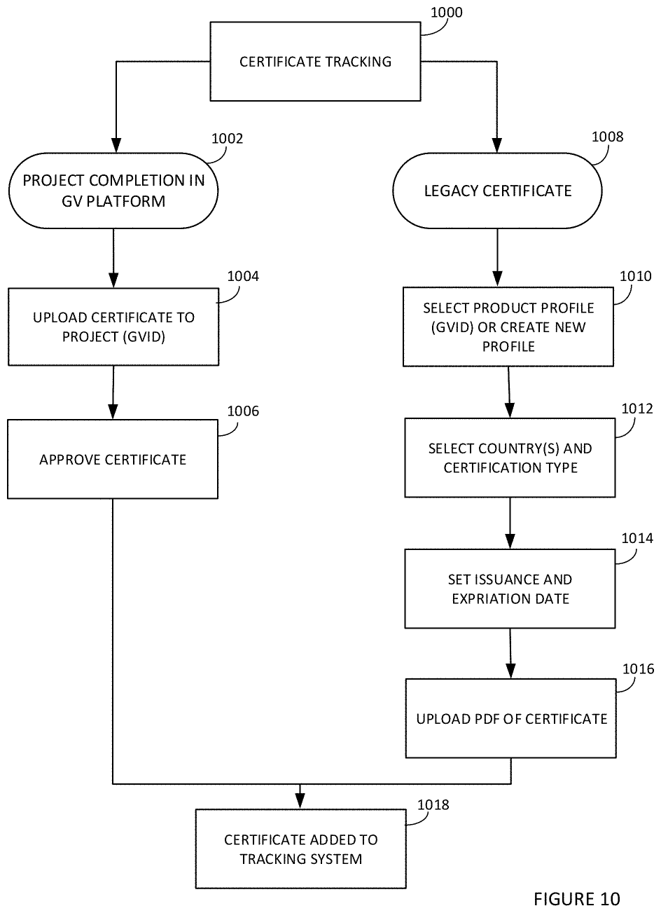

Turning now to FIG. 10 this figure presents a flow diagram for the certificate tracking process consistent with certain embodiments of the present invention. In an embodiment, the process of certificate tracking 1000 begins with the selection of a testing and/or certification project initiated with the certification system. At 1002, if the testing and/or certification process has been completed in the Global Validity (GV) certification system the project completion has been noted and recorded in the GV certification system. At 1004, the completed testing and/or certification document is uploaded to the project associated with the testing and/or certification through the use of an identifier (GVID) by which the certificate is connected to the project. At 1006, the project manager is presented with the uploaded certificate for approval as a final check on the completion of the project and the verification of completion of the testing and/or certification.

If the testing and/or certification process is initiated for a legacy certificate, either a certificate previously certified by the certification system or imported from a third-party testing and/or certification process, at 1008 the legacy certificate is surveyed to determine the product that is associated with the legacy certificate. At 1010, the product is used as a key to select the product profile maintained within the certification system through the use of the GVID, or, for products that have been certified by a third-party testing and/or certification process, a new product profile and assignment of a newly created GVID are created for the product associated with the legacy certificate. At 1012, the country testing and/or certification types for the product are identified and added to the product profile for the legacy certification as information about the product. At 1014, the certification system sets the issuance and expiration dates for the legacy certificate to permit the update to the legacy certificate upon completion of the testing and/or certification process for the product associated with the legacy certificate. At 1016, the project management system uploads the updated legacy certificate in pdf format to the project tracking system.

Whether the certificate is generated by the GV platform or is an updated legacy certificate, upon completion of the approval step or the upload of the updated certificate, the verified and approved certificate is uploaded to the tracking system at 1018 for later retrieval and transmission to the user or authority requesting the testing and/or certification for the particular product.

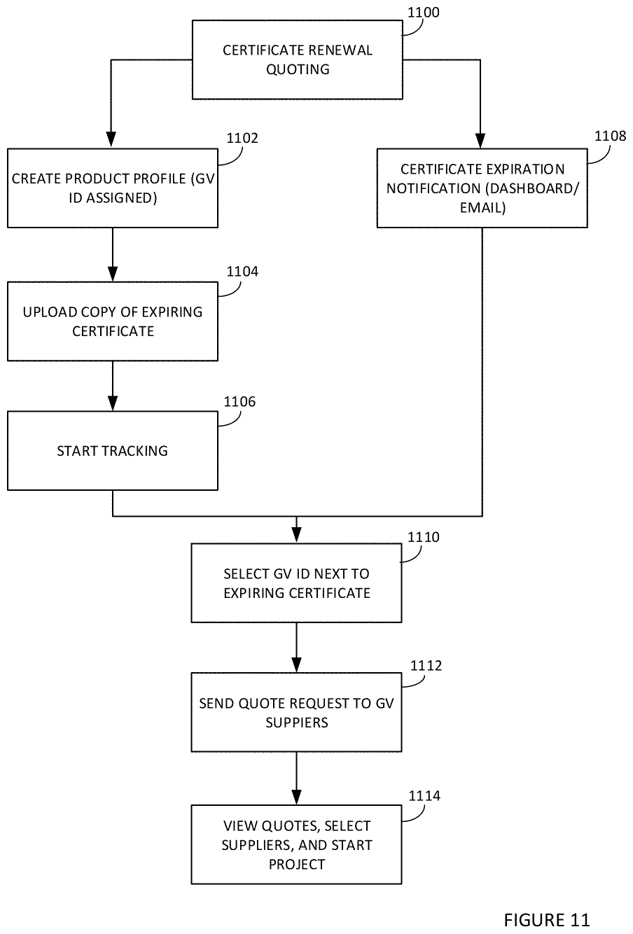

Turning now to FIG. 11 this figure presents a flow diagram for the certificate renewal quoting process consistent with certain embodiments of the present invention. In an embodiment, the certification system may maintain a database of operational certificates that have been processed and include the dates when such certificates must be renewed to maintain operational status for the product identified in the certificate. At 1100, the certification system may track these renewal date fields and prepare initiate a quote for the renewal of the certificate for each product that is nearing a renewal date event. At 1102, the testing and/or certification renewal process may create a product profile by looking up the product utilizing the GVID that has previously been assigned for the product and is available in the product file maintained by the certification system. At 1104, the certificate renewal process may access the product file and upload a copy of the expiring certificate from the product file. At 1106, the expiring certificate and expiration date are uploaded to the project tracking system and the renewal process initiates. Simultaneously, at 1108 a notification message indicating the expiration of the certificate is formatted and transmitted as a notification to the user. The certificate renewal process may transmit this notification both through the user dashboard and as an email message to the user or authority that is identified as the responsible party for the product named in the certificate.

At 1110, the project tracking process of the certification system selects the GVID of the product named within the expiring certificate. At 1112, the certificate renewal process formats and transmits a quote request that is populated from the tracking file for the particular product named in the expiring certificate to one or more third-party suppliers of testing and/or certification services. At 1114, the certification compliance management system certificate renewal process may receive one or more quotes for the ng and/or renewal. The certification system may then evaluate the supplier's quotes, select one or more suppliers to provide the re-certification service and send an acceptance to those suppliers selected. The selected suppliers may be added to the tracking profile for the product within the project tracking process to track the progress and manage the process of ng and/or renewal for the expiring certificate.

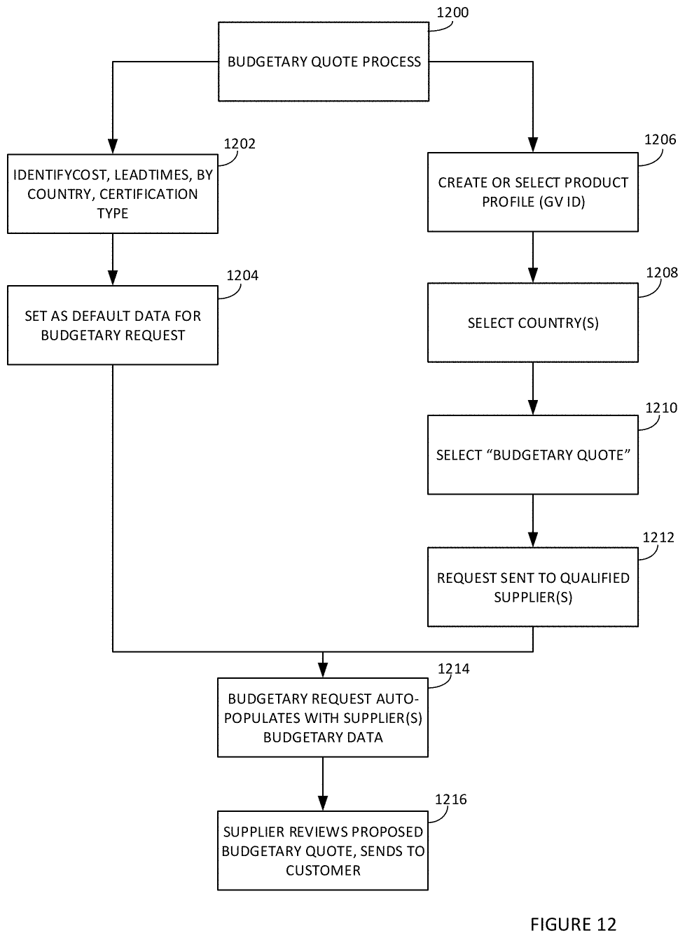

Turning now to FIG. 12 this figure presents a flow diagram for the budget quote process consistent with certain embodiments of the present invention. In an embodiment, when a customer requires a testing and/or certification the initial step is to seek a quote for such service. The certification compliance management system accommodates this requirement through the initiation of a budgetary quote process at 1200. For new products or projects, the certification compliance management system will identify cost and lead times and prepare this information on a per country and per certification basis at 1202. This information is set as the default information for this project in the project file maintained by the certification compliance management system at 1204.

For those products that are currently stored in files within the certification compliance management system or for new products that are being produced by a current client, at 1206 the budgetary quote process may create a new GV ID for new products or retrieve the GV ID for products that are known to the certification compliance management system. The budgetary quote process may then select countries for inclusion in the quote process at 1208. The budgetary quote process will be activated by the selection of the “budgetary quote” selection field on the application display at 1210. This selection will complete the information required for the quote request and the completed quote request may then be sent to one or more suppliers of testing and/or certification services at 1212.

At 1214, the budgetary quote process may auto populate a budgetary quote with all of the information specific to the quote and to the particular supplier. This populated quote may then be transmitted to the one or more suppliers for their review at 1216. The supplier may then transmit the proposed budgetary quote to one or more customers for their action.

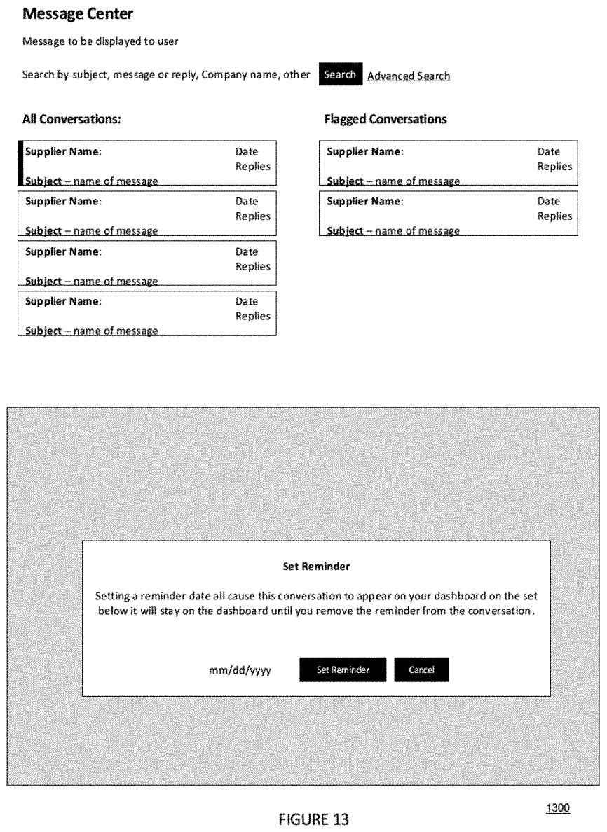

Turning now to FIG. 13 this figure presents a flow diagram for the message center operation consistent with certain embodiments of the present invention. In an embodiment at 1300, the certification compliance management system may provide a message center function within the certification dashboard display for use by clients when communicating between users within the certification compliance management system. The message center function is available to users at any time the user may wish to access communication capability within the certification compliance management system. The message center may categorize conversations between users and suppliers by displaying flagged conversations and all conversations for access by a user and/or a supplier. Once selected, the message center may open a text-based conversation capability for passing messages between parties, whether the parties are users or suppliers, who have accessed the message center capability.

Additionally, the message center permits the user or client to set reminders associated with particular conversations to permit users or clients to trigger responses in a timely fashion based upon actions and when they may occur during the prosecution of testing and/or certification projects. These reminders may remain on the dashboard until specifically dismissed by the user or client.

While certain illustrative embodiments have been described, it is evident that many alternatives, modifications, permutations, and variations will become apparent to those skilled in the art in light of the foregoing description.

1. A system for device testing and certification, comprising:
a server having a data processor;
said data processor configured to accept a request for testing and certification services for a device;
said data processor receiving requested product configuration, operation parameters, and country information from a requestor for one or more countries;
said data processor transmitting a request for quote for said testing and certification services comprising said received product certification to certify operation capability and country information for multiple countries, and further comprising testing and/or consulting requests to at least one external supplier or third-party supporting each country for which country information is supplied;
said data processor receiving at least one quote from said at least one external supplier and at least one third-party in each country for which country information is supplied in said request for quote;
said data processor displaying the at least one quote from said at least one external supplier and said at least one third-party in each country to a user and receiving an acceptance of at least one quote from said user for each country;
said data processor creating a testing and certification project including each country for which the at least one quote has been accepted;
said data processor creating said testing and certification project and receiving and enabling product requirements from each included country to generate an operation compliance certification for each of said multiple countries;
the testing and certification project tracking and managing the certification and testing requirements and application for each of said one or more countries until the testing and certification project is complete;
the testing and certification project creating a device application as the result of said testing and certification project to generate a certificate of operation and said requestor downloading a physical and electronic copy of said certificate of operation for said device for each country for which country information is supplied.

2. The system of claim 1, further comprising collecting device information comprising at least requirements, device parameters, and project information and storing all collected information in an electronic storage element maintained within said server.

3. The system of claim 1, further comprising a user sharing pre-selected data by transferring a secure communication link to a third-party to re-direct said third-party to the platform to directly access said pre-selected data.

4. The system of claim 1, where the request for testing and certification services identifies one or more countries and jurisdictions in which said device will operate.

5. The system of claim 1, where the request for a quote for said testing and certification services is transmitted to at least one supplier, or third party, that has been previously qualified to provide said testing and/or certification services in one or more countries.

6. The system of claim 1, where the testing and certification project is configured to manage, process, engage, coordinate, gather, retain, and lock all information about said devices within said electronic storage element.

7. The system of claim 5, where the testing and certification project manages one or more certification processes by tracking and providing service management to achieve approvals, manage data and documents files, and manage testing and/or certification documents.

8. The system of claim 6, where the testing and certification project controls and manages all communication between requestors, suppliers, and third-party participants.

9. The system of claim 7, where the testing and certification project management further comprises control and management of chats, descriptions, briefings, and notes among requestor, supplier, and third-party participants.

10. The system of claim 1, further comprising said testing and certification project maintains and tracks each testing and certification application for the entirety of the project and provides each requestor, supplier, and third-party participant with all jurisdiction requirements for each device to be certified.

11. The system of claim 9, where said jurisdiction requirements further comprise any of labeling, standards, and operational requirements for each jurisdiction specified for each testing and certification project.

12. The system of claim 1, where said testing and certification project further details projected and actual testing and certification project efforts and supports open market competitive bidding for all pricing of testing and certification services.

13. The system of claim 1, where the testing and certification project provides synthesis and reporting of all information for each testing and/or certification project of all information collected for said each testing and/or certification project.

14. The system of claim 1, further comprising an analytic process to analyze all project information and provide metric and other analytical results to a user.

15. The system of claim 1, further comprising encryption and data communication security of all data collected by the system for each testing and certification project managed by the testing and certification application.

16. The system of claim 14, further comprising managing data communication security through encrypted protection for data and transactions occurring during said testing and/or certification project.

17. The system of claim 1, where all communication external to said system is managed through a protective firewall.

18. The system of claim 1, further comprising renaming incoming or outgoing files to a pre-defined nomenclature configured by each individual user and organizing said incoming or outgoing files according to said pre-defined nomenclature.
